(19) United States
(12) Patent Application Publication
(10) Pub. No.: US 2012/0072317 A1
(43) Pub. Date: Mar. 22, 2012

(54) BILLING MANAGEMENT SYSTEM FOR AGRICULTURAL SERVICES ACCESS

(75) Inventor: Christopher Burton O'Neil, Wichita, KS (US)

(73) Assignee: AGCO CORPORATION, Duluth, GA (US)

(21) Appl. No.: 13/237,008

(22) Filed: Sep. 20, 2011

Related U.S. Application Data
(60) Provisional application No. 61/384,472, filed on Sep. 20, 2010.

(51) Int. Cl. G06Q 30/00

(52) U.S. Cl. 705/30

(57) ABSTRACT

Billing for application services may be provided. A plurality of data may be received from a machine. The machine may be determined to be associated with a subscribing user, and an application service associated with the machine may be identified. The plurality of data may be provided to the application service and a charge record associated with the subscribing user may be created.

### RELATED APPLICATIONS

Under provisions of 35 U.S.C. §119(e), the Applicants claim the benefit of U.S. provisional application No. 61/384,472, filed Sep. 20, 2010, which is incorporated herein by reference.

Related U.S. patent application Ser. No. 12/915,803, filed on Oct. 29, 2010, and entitled “Agricultural Inventory and Invoice System,” assigned to the assignee of the present application, is hereby incorporated by reference.

Related U.S. patent application Ser. No. 12/915,792, filed on Oct. 29, 2010, and entitled “Dynamically Triggered Application Configuration,” assigned to the assignee of the present application, is hereby incorporated by reference.

Related U.S. patent application Ser. No. 12/915,777, filed on Oct. 29, 2010, and entitled “Trigger-Based Application Control,” assigned to the assignee of the present application, is hereby incorporated by reference.

Related U.S. patent application Ser. No. ______, filed on even date herewith and entitled “Allocating Application Servers in a Service Delivery Platform,” assigned to the assignee of the present application, is hereby incorporated by reference.

Related U.S. patent application Ser. No. ______, filed on even date herewith and entitled “Evaluating Triggers for Application Control and Machine Configuration,” assigned to the assignee of the present application, is hereby incorporated by reference.

Related U.S. patent application Ser. No. ______, filed on even date herewith and entitled “Self-Provisioning by a Machine Owner,” assigned to the assignee of the present application, is hereby incorporated by reference.

Related U.S. patent application Ser. No. ______, filed on even date herewith and entitled “Dynamic Service Generation in an Agricultural Service Architecture,” assigned to the assignee of the present application, is hereby incorporated by reference.

### BACKGROUND

Agricultural service billing and invoicing may be provided. In conventional systems, access to application services can be cumbersome, requiring interaction with multiple, non-integrated service providers. Equipment operators must often provide data to multiple analysis applications, often operated by different entities, and deal with a multitude of billing systems, receivable due dates, and invoice formats. This often causes problems because the operators spend needless time reconciling multiple accounts.

### SUMMARY

A billing system for application services may be provided. A plurality of data may be received from a machine. The machine may be determined to be associated with a subscribing user, and an application service associated with the machine may be identified. The plurality of data may be provided to the application service and a charge record associated with the subscribing user may be created.

It is to be understood that both the foregoing general description and the following detailed description are examples and explanatory only, and should not be considered to restrict the invention's scope, as described and claimed. Further, features and/or variations may be provided in addition to those set forth herein. For example, embodiments of the invention may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram illustrating an operating environment;

FIG. 2 is an illustration of an example work area;

FIG. 3 is a flow chart of a method for providing billing for agricultural services; and

FIG. 4 is a block diagram of a computing device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention.

Embodiments of the present invention may provide for a system and method for providing agricultural inventorying and invoicing. An agricultural implement, such as a hay baler implement coupled to a tractor, may be automatically configured and monitored before, during, and after operation in a work area. Upon leaving the work area, reports such as an inventory count and location of gathered hay bales may be generated and transmitted to a central system, such as a farm owner's computer-based inventory application. Consistent with embodiments of the invention, invoices for the work performed may be generated according to factors such as time and material efficiency and amount of harvested material gathered and similarly transmitted to the central system.

For example, an independent contractor may be retained to harvest a crop in a given field. The equipment operator may couple an appropriate implement (e.g. a combine harvester) to a tractor. The system may identify the type of implement and retrieve a work order from a central system identifying a field location. A GPS system in the tractor may direct the operator to the field and/or pilot the tractor to the field using an autosteer system. The GPS system may determine when the implement has entered the work area according to a geo-boundary that may be provided with the work order. Upon receiving the work order and/or upon detecting that a trigger associated with entering the work area has occurred, an appropriate application may be transmitted to a computer onboard the tractor, such as a hay baling application operative to inventory the number of bales created, tag the bales' locations in the field for later retrieval, and/or measure the quality, yield, moisture content, etc., associated with each bale. Another trigger may occur upon leaving the work area that may cause the application to finalize the recorded information, transmit a report and/or invoice to the central system.

Dynamic application configuration may be provided to enable the automatic selection of an appropriate farm management information (FMIS) application according to implement and/or tractor type, the location, a time and/or date, information captured by sensors coupled to the implement and/or tractor. The application configuration may identify what work implements are available for coupling to the tractor, what work needs to be done in which fields, which operators are available, and may comprise a priority task list based on factors such as weather forecasts, current market prices, scheduling requirements, etc.

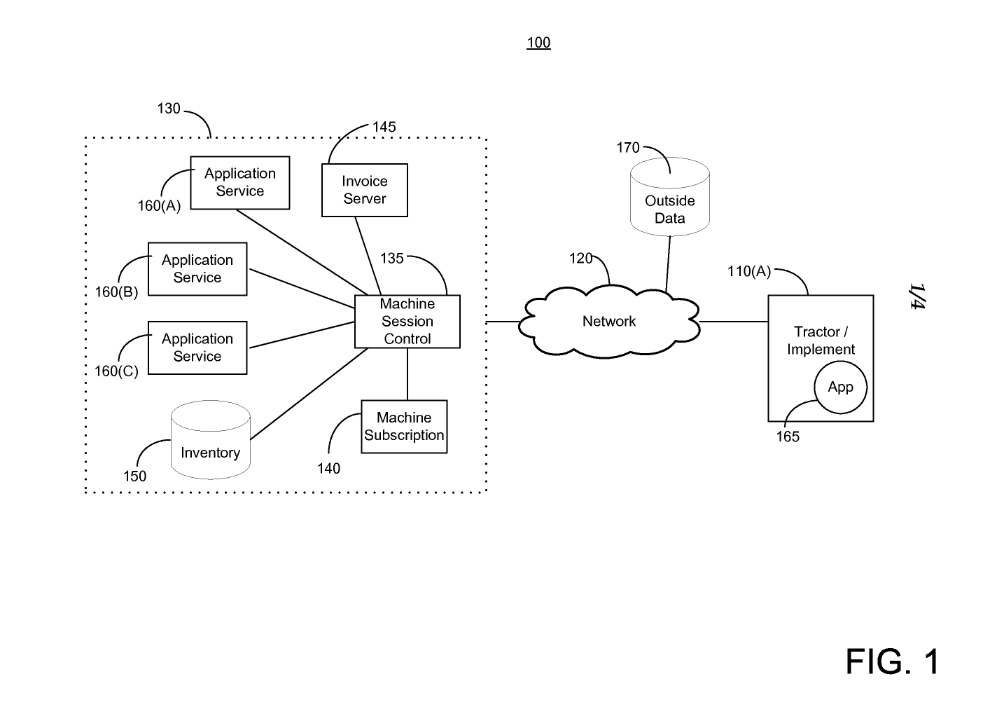

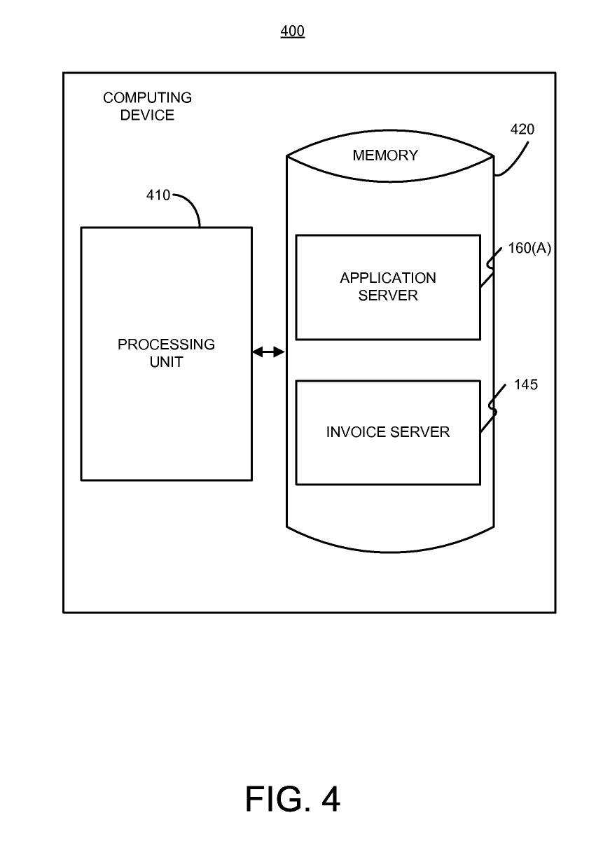

FIG. 1 illustrates an operating environment 100 for providing an agricultural inventory and invoice system. Operating environment 100 may comprise a tractor/implement 110 coupled via a network 120 to a central system 130. Tractor/implement 110 may comprise a tractor capable of being coupled to a plurality of different work implements (e.g., harvesters, balers, irrigation implements, fertilizing implements, tillers, trailers, crane arms, etc.) and/or a single machine such as a flatbed truck. Network 120 may comprise a communication medium such as a wireless, radio, and/or cellular network. Central system 130 may comprise a plurality of applications that may execute on a computing device 400, described below with respect to FIG. 4, and/or a plurality of different communicatively-coupled computing devices. The applications may comprise a machine session control server 135, a machine subscription server 140, an invoice server 145, an inventory database 150, and/or a plurality of application servers 160(A)-(B). Other elements not shown may also be included in central system 130, such as weather forecasting applications, price tracking applications, yield and/or efficiency reporting applications, and/or operator databases comprising information such as wages and trained skills and proficiencies. Central system 130 may also be operative to communicate with and send and/or retrieve data from an outside data source such as a crop market price and/or weather service.

Central system 130 may be operative to identify whether tractor/implement 110 is associated with an application subscription according to machine subscription server 140 and may download an application 165 to tractor/implement 110 appropriate to a current work assignment. Application 165 may be configured to perform certain functions upon the occurrence of trigger events such as recording a start time and/or initiating data recording when tractor/implement 110 enters a field and/or transmitting a report or invoice when tractor/implement 110 leaves the field.

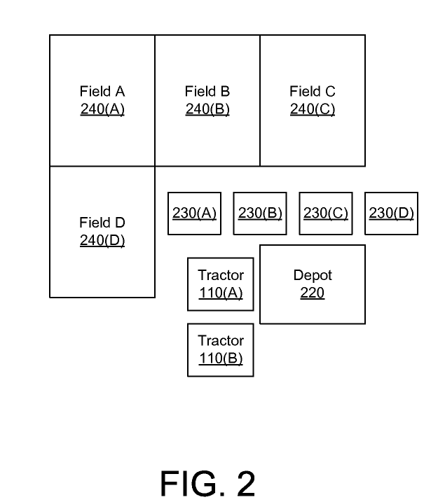

FIG. 2 illustrates an example work area 200. A plurality of tractors 210(A)-(B) may arrive at a depot 220 in the morning. Central system 130 may be located at depot 220 and/or offsite may communicate with tractors 210(A)-(B) via a communication medium such as a wireless, radio, and/or cellular network. The tractor operators may be identified according to skill sets, operation costs (e.g., equipment costs and/or operator wages) and/or tractor capabilities (e.g., tractor 210(A) may comprise a more powerful engine better suited to a heavier work implement than tractor 210(B) and/or tractors 210(A) and/or tractor 210(B) may already have a work implement coupled). The central system may also comprise a list of available work implements such as plurality of implements 230(A)-(D) and/or work areas, such as a plurality of fields 240(A)-(D). For example, work implement 230(A) may comprise a combine harvester, work implement 230(B) may comprise a hay baler, work implement 230(C) may comprise a fertilizer, and work implement 230(D) may comprise a hay bale gatherer. Field 240(A) may comprise a hay field ready for baling, field 240(B) may comprise a hay field that has already been baled but in need of retrieval, field 240(C) may comprise a corn field in need of fertilizing, and field 240(D) may comprise a field in need of tilling.

The central system may provide a work assignment to one and/or more of tractors 210(A)-(B). For example, if tractor 210(A) already has a hay baler implement coupled, tractor 210(A) may be assigned to field 240(A). If tractor 210(B) does not yet have an implement coupled, central system 130 may provide a work assignment according to a work priority list and/or tractor 210(B)'s (and/or its operators) capabilities and/or costs. For example, a weather forecast may provide for rain in the afternoon. Collection of baled hay from field 240(B) may receive a higher priority than fertilization of field 240(C) in order to minimize damage to the quality of the baled hay and/or to avoid excess fertilizer runoff.

Application configurations, triggers, and/or work orders may be downloaded prior to beginning work and/or updated as information is gathered. For example, at the beginning of the work day, a hay baler application (e.g., work application 165) may be downloaded to a tractor/implement 110. if a hay baler application detects that the gathered material is becoming too wet, an updated work order may direct the operator to another work location and/or transmit a location according to the GPS identifying the material for a later attempt. Similarly, if a yield and/or quality measurement determines that the cost of having the operator in a particular location is greater than the value of the crop being harvested, the operator may be directed to increase speed so as to finish the area faster, accepting a lower yield and/or quality in exchange for the operator reaching a higher value area sooner.

Consistent with embodiments of the invention, central system 130 may identify various fields such as fields 240(A)-240(B) and track past work done, current work needed, and/or future work expected. For example, field 240(A) may comprise a plurality of work assignments, their required order, and their status such as: tilled—completed, planted—completed, cut—completed, baled—pending, collected—waiting for baling. The completed assignments may be associated with recorded data such as time spent, costs incurred, yields, quality measurements, etc. As tractor/implement 110 enters boundaries identified for field 240(A), central system 130 may determine whether tractor/implement 110 comprises an appropriate implement for the current work needed in that field. If tractor/implement 110 comprises a hay baler implement and field 240(A) is currently in need of baling, central system 130 may download application 165 as a hay baling application and instruct tractor/implement 110 to begin operation in field 240(A). Application 165 may comprise configuration and/or trigger information such as acceptable moisture content such that if a sensor coupled to tractor/implement 110 detects an unacceptably high moisture level, application 165 may reconfigure for new instructions, such as skipping the wetter areas, tagging their location for later re-attempts, and reporting the problem to central system 130. Other trigger examples may comprise a fuel cost/mileage reporting upon completion of the work (triggered by leaving the field boundary and/or returning to depot 220), providing new instructions to tractor/implement 110 such as directing it to another field to perform similar work or returning to depot 220 to change implements), and/or generating and/or transmitting invoice data to central system 130 associated with the completed work as measured by application 165.

Triggers may comprise automatic start, stop, and/or reconfiguration instructions that may be associated with tractor/implement 110 such as a location, a time/date, a capability, an attached implement, and/or data collected by tractor/implement 110. Triggers may comprise a condition (and/or a plurality of conditions) and an action. For example, a first trigger may comprise the conditions of entering field 240(A) with a hay baler implement attached and an action of initiate hay baler application. A second trigger may become active only after the first trigger has fired, such as one comprising a condition of leaving field 240(A) and an action of reporting gathered data to central system 130.

An example use case may be as follows. Tractor 210(A) may receive a plurality of triggers from central system 130. As tractor 210(A) enters field 240(D) with a hay baling implement attached, triggers may fire associated with field 240(D) to determine whether appropriate work is available for field 240(D). If field 240(D) is currently in need of fertilizing, however, tractor 210(A) has the wrong implement and so no application may be initiated. As tractor 210(A) crosses the boundary into field 240(A), which may be in need of hay baling, a trigger may fire that causes central server 130 to transmit a hay baling application comprising configuration information, data recording instructions, and/or operator instructions to tractor 210(A). The hay baling application may initiate based on the trigger firing and may, for example, provide a suggested route via a GPS display to an operator of tractor 210(A) and/or initiate data recording associated with the working of the hay baling implement.

Other triggers may be operative while the hay baling application is executing. For example, outside data source 170 may provide hay bale prices data to central server 130 enabling a trigger condition based on yield data collected by tractor 210(A). A predicted market value of the hay being baled by tractor 210(A) may be calculated and compared to predicted costs such as operator wages and equipment and fuel costs. If the projected profit is below a configurable threshold, the trigger may fire to stop the application and direct the operator of tractor 210(A) to cease operations in field 240(A). Another trigger may comprise a moisture level threshold that may direct the operator to skip some and/or all of field 240(A) if the moisture content of the hay is too high. The skipped areas may be recorded and transmitted back to central system 130, such as on the firing of another trigger comprising a condition of leaving the boundaries of field 240(A). A single trigger condition, such as leaving the field, may comprise multiple resulting actions, such as requesting new instructions for the operator and transmitting inventory and collection data to central system 130. For example, the hay baling application may transmit data comprising a GPS location for each bale ready for pickup and may comprise additional data such as warnings about which bales may comprise a higher moisture content than desired and so may require special handling.

Agricultural technology domain areas (ATDA) may comprise features and functionality used by a farmer to provide management, logistics, planning and operational efficiencies in the application and harvesting of material. A farmer may have access to many machines and implements that may comprise different makes, models, and have different configurations that generate unstructured process data. Consistent with embodiments of the invention, an architecture layer, referred to herein as an Agricultural Application Control Subsystem (AACS), may be provided allowing user and/or location based customization and configuration independent of the underlying machine specific implementations. Applications may be designed for use with multiple makes and models by relying on the architecture layer to translate abstracted instructions (e.g., “collect moisture level data”) into specific control instructions for a given implement.

Tractor 110 may provide data through a standardized interface, such as that described by ISO 11783 over network 120 to central system 130, which may then store and/or convert the data into a standard format (e.g., XML) and/or a proprietary format associated with a particular data management application. The converted data may be made available to a farmer through an interface application, such as on a personal computer and may be used by value-added service applications, such as profit and loss analysis applications. Further, data from different machines may be collected, converted into a common format, and aggregated for use in a single analysis application. A closed loop architecture comprising a machine and a server in communication may be used. Process data may be sent to the server, analyzed, and adjustments may be made to the machine's configuration.

The AACS may comprise a three-layer architecture structure. A first layer may comprise a transport plane comprising physical resources necessary for a connection from the agricultural machine to a middle layer. The middle layer may comprise a control plane that may comprise intelligent elements that may determine whether a data from a tractor is allowed to enter the network and which ATDA(s) to invoke in a top layer. The top layer may comprise an application plane where the ATDA(s) reside. The lower layer may be represented, for example, as a combination of a cellular network and a mobile application system, the AACS, and a network application system.

The AACS may be responsible for examining each process-data record as it enters central system 130. This examination may be implemented, for example, via machine session control server 135 and/or machine subscription server 140. AACS may provide session control by recognizing that a machine may be generating process-data and that it may be possible to provide additional features and functionalities to the machine or to the ATDA service provider's application. A session may comprise a path of the data to ATDA service provider(s) from the machine and visa versa. Session control may allows establishment of a session and/or two-way transmission between central server 130 and tractor 110 during the life time of that session. An example of a service may comprise the storage of process data, such as in inventory database 150. Once the machine starts sending data, a session may be started by creating a path between the machine data and the storage service. If the data includes GPS coordinates it may be possible during the session life time to engage another service such as a geofence analysis.

A geofence may comprise a virtual perimeter for a real-world geographic area. When a location-aware device of a location-based service (LBS) user enters or exits a geofence, the device receives a generated notification. This notification might contain information about the location of the device. Geofencing is an element associated with telematics hardware and software. It may allow users of the system to draw zones around places of work, customers sites, fields, and/or secure areas. These geofences, when crossed by an equipped vehicle or person may trigger a notification to the user or operator.

Through session control, the AACS may allow the determination of routing information (address) for a machine (e.g. for sending updated information, content adaptation for incompatible devices (e.g. converting units of captured data to the ISO 11783 standard), and interworking between different access networks. Session control may further enable the provision of application logic not natively available in devices (e.g. data corrections and auto field detection algorithms or the addition of coding data like an operator's name) and supplemental outside information for the application (e.g. weather information or commodity pricing). Session control may also provide store and forward capabilities when one ATDA service provider is not connected (e.g. the user of a FMIS software package is not at the computer) or when a machine is not in coverage. Session control may also offer authentication and authorization functionality.

The AACS architecture may provide two mechanisms with which to blend applications already deployed in the network to create new ATDA services—Initial Filter Criteria (IFC) and service brokering. The iFC may comprise a set of prioritized trigger points assigned to a subscriber's profile that indicate the order in which multiple application servers (e.g., application servers 160(A)-(B)) may be invoked depending on what services a user has subscribed to.

IFC implementation may use triggers that may define a set of conditions under which a particular application server is notified about the existence of data. Particular conditions may be provided in the form of regular expressions. IFCs may define a correlation between a set of triggers and particular application server(s) responsible for execution of the associated service logic. The process data flow through the AACS may begin with the machine (e.g., tractor 110) capturing data and sending it to session control server 135 of central system 130. The process data from the machine may be parsed and a machine ID may be captured. The machine ID may be sent to machine subscriber server 140 to determine if the machine is allowed to enter this server (e.g. authentication and/or determination of whether the machine is an active paid subscriber). The applications that the machine has subscribed to may be returned to session control server 135 in the form of application profiles. Session control server 135 may examine each telemetry message against the IFC contained in the application profile(s); if a match occurs, the session may be assigned to an Application Server. The IFC may be able to select an application server based on the process data. That is, central server 130 may dynamically assign each session to a service. For example, if the process data does not include the speed of the machine but does include GPS, then a session may be dynamically assigned to a speed-as-a-function-of-GPS data service.

The service brokerage may comprise a set of rules that govern service invocation during the life time of a session. The application profile may assign a quality of service (QoS, e.g., a required speed or performance of the network) value to force a route used by the assigned application server to allow real time access to the data.

Application services may be offered as packages and/or individual applications that may incur a one-time, a periodic, and/or a recurring cost. A flexible charging mechanism may allow a network operator to offer a differential value beyond just set pricing or monthly fees. Pricing scenarios may be supported in the ACSS such as prepaid, postpaid, machine owner pays, ATDA service provider pays, and/or data storage costs (e.g., pay per data increment consumed and/or made available). Application services may comprise, for example, data analysis applications, external data provider applications, auto field detections algorithms, data shaping algorithms, mapping services, invoicing services, geofencing services, SMS services, e-mail services, streaming audio and/or video, and/or firmware and/or software application upgrade services. Each session may be associated with a set of services invoked as desired by the end user and/or the ATDA service provider. A list of services invoked, the time, date and length of invocation may be captured in a Charging Data Record (CDR). The CDR is then used by a billing entity against a rate sheet to create a bill.

The following use case is provided as a non-limiting example of embodiments of the invention. A farmer may create a new application called “Baler Inventory and Invoice.” Central system 130 may request the farmer to configure the application by providing details such as a location, desired equipment and/or operators, and/or scheduling data. The farmer may configure the application for use in field 240(A) when he is using tractor 110(A) with implement 230(A). The farmer may use two triggers such as geofence and machine configuration. He may assign the field name to the geofence trigger and the machine configuration to a machine and implement triggers.

The Initial Filter Criteria may be created to define when and where to start the application. In addition, the application may also know when to stop. Two filters may be created as shown below. A session may be started once the condition(s) of Example Trigger 1 are met and the session may remain active until an end condition such as Example Trigger 2 is satisfied.
If GeoFence==field 240(A) &&
If Machine==tractor 110(A) &&
If Implement==implement 230(A) &&
Then Start the Baler Inventory and Invoicing Application
Example Trigger 1
If Application==implement 230(A) &&
If Application==Started &&
GeoFence !=field 240(A)∥
If Machine !=tractor 110∥
If Implement !=implement 230(A)∥
Then Stop the Baler Inventory and Invoicing Application
Example Trigger 2

The application provisioning process may store the IFC as part of the farmer's application profile for that machine into machine subscription server 140. The ACSS may continuously monitor process data from all machines. Machine process data may be sent to an application control function and its data may be parsed and sent to machine subscription server 140. Machine subscription server 140 may find the application profile and return the IFCs. Until the triggers for the Baler is met, the data may be stored via a default process. Each time a set of process data is sent to the ACF, it may be parsed and examined to perform machine authentication, load in the application service profile, and executes the IFCs. For example, the geofences service may be invoked to determine whether the machine is in the trigger field.

If the process data matches the IFC, a session (a stateful program counter that assist in application control) may be created and a Session Detailed Record (SDR) for billing purposes may be generated. A message may be sent to one of application servers 160(A)-(B), such as applications server 160(A), comprising the SDR and an instruction to start the baler application. Application server 160(A) may receive the message, parse the SDR, and begins work. Application server 160(A) may download the baler application and/or a task to a task controller on tractor 110(A) so that the machine may capture the correct data. For example, the baler application may be transmitted to tractor 110 as application 165. Application 165 may begin to query the machine process data. The process data may allow application 165 to count the number of bales and record the location of the bales. Session control server 135 may monitor the machine process data until the IFC that ends the application is met. An SDR associated with stopping the application may be sent to application server 160(A), the application may be stopped, and the SDRs may be logged to be retrieved by a billing system such as invoice server 145.

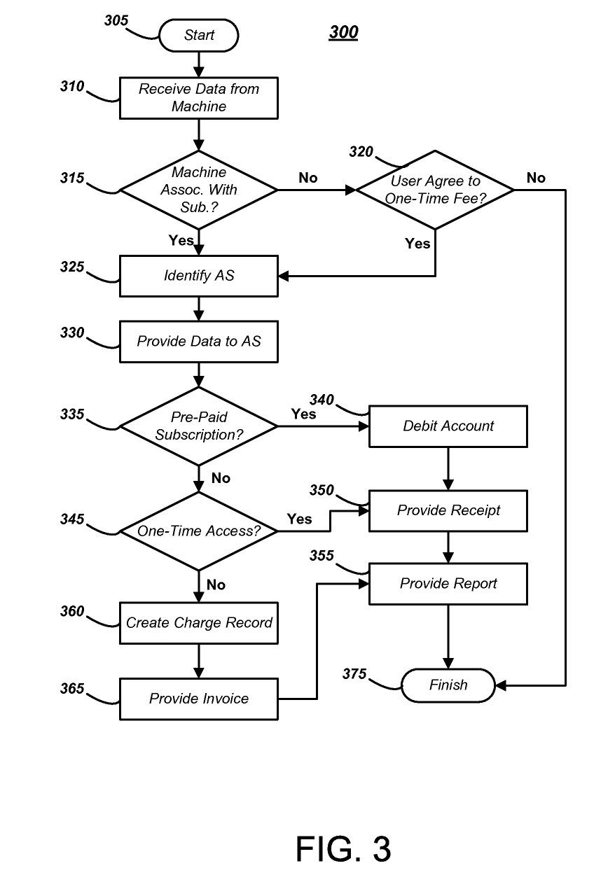

FIG. 3 is a flow chart setting forth the general stages involved in a method 400 consistent with an embodiment of the invention for providing billing services for agricultural applications. Method 300 may be implemented using computing device 400 as described in more detail below with respect to FIG. 4. Ways to implement the stages of method 300 will be described in greater detail below. Method 300 may begin at starting block 305 and proceed to stage 310 where computing device 400 may receive a data transmission from a machine. For example, data (such as a harvested quantity of agricultural material) gathered by tractor/implement 110(A) may be transferred to central system 130. The transfer may comprise, for example, a mechanism such as a portable data storage device (e.g., a flash drive) and/or a wireless or wireline data transfer, such as over network 120.

From stage 310, method 300 may advance to stage 315 where computing device 300 may determine whether the machine providing the data is associated with an active subscription. For example, the data transfer may comprise a machine identifier associated with an owner and/or operator of the machine. A database may comprise a plurality of subscription entries associated with machine identifiers allowing computing device 300 to look up any entries comprising the received machine identifier.

If the machine is not associated with a subscription, method 300 may advance to stage 320 where computing device 400 may determine whether a one-time access to a service may be authorized. For example, an operator of tractor/implement 110(A) may transfer data to central system 130. Upon determining that the machine is not associated with an active subscription, central system 130 may display a message to the operator comprising a usage agreement and/or one time access fee. The operator may choose to accept or decline the access and/or may pay for access to the service, such as through a credit card processing system. Such credit card processing systems are known in the art. Consistent with embodiments of the invention, authorizing access to the service may comprise receiving an address to which an invoice may be sent, receiving a purchase order number, and/or another method of authorizing and/or agreeing to pay any access fees associated with the desired application service. If no one-time usage is authorized, method 300 may end at stage 375.

If the operator authorizes the one-time access at stage 320 or after determining that the machine is associated with a subscription at stage 315, method 300 may advance to stage 325 where computing device 400 may identify an application service associated with the machine and/or the subscription. For example, the subscription may be associated with a harvest yield calculation service.

From stage 325, method 300 may advance to stage 330 where computing device 300 may provide the data to the application service. For example, central system 130 may transfer the data to application service 160(A) for analysis.

From stage 330, method 300 may advance to stage 335 where computing device 300 may determine whether the subscription is a pre-paid subscription. For example, central system 130 may determine whether an owner and/or operator associated with the machine maintains an account associated with the subscription through which funds are made available to central system 130 prior to accessing any of the associated application services.

If so, method 300 may advance to stage 340 where computing device 400 may debit the pre-paid account. For example, the pre-paid subscription account may comprise a $10,000 deposit. Each access of application service 160(A) may be associated with a $100 fee. Upon providing the data the application service 160(A), computing device 400 may debit the account for $100, leaving a $9900 balance. Consistent with embodiments of the invention, computing device 400 may be operative to determine when the account drop below a threshold balance and may notify a contact associated with the subscription and/or charge an account, such as a bank account or credit card, to replenish the account's balance.

If the machine is not associated with a pre-paid subscription, method 300 may advance to stage 345 where computing device 400 may determine whether the use of the application service was associated with a one-time access purchase, as described above. If so, or after debiting the account in stage 340, method 300 may advance to stage 350 where computing device 300 may provide a receipt to a contact associated with the data analysis. For example, a receipt may be printed out, emailed, and/or sent via text message to the operator of tractor/implement 110(A) after the data has been provided to application service 160(A).

If the machine is not associated with a one-time access, method 300 may advance to stage 360 where computing device 300 may create a charge record. For example, central system 160 may create an entry in a billing database of invoice server 140 comprising a time/date of the transaction, a machine identifier, an operator identifier, and/or which application service was accessed. This entry may be associated with the subscription identified in stage 315, above.

From stage 360, method 300 may advance to stage 365 where computing device 300 may provide an invoice. For example, invoice server 140 may generate an invoice comprising a single charge record and/or a plurality of charge records. Consistent with embodiments of the invention, an invoice may be generated comprising charge records generated over a period, such as each month. The invoice may also indicate whether any previous invoices are past due. The invoice may then be provided to a contact associated with the subscription, such as via e-mail, a web page, a text message, and/or as a hardcopy print out that may be hand delivered or mailed.

After the receipt or invoice is provided at stage 350 or 365, respectively, method 300 may advance to stage 355 where computing device 400 may provide a report. For example, central server 130 may receive a report detailing an analysis of the data from application service 160(A). This report may be provided to the operator and/or owner of the machine, such as e-mail, a web page, a text message, and/or as a hardcopy print out. Method 300 may then end at stage 375.

FIG. 4 illustrates computing device 400 as configured to operate as central system 130. Computing device 400 may include a processing unit 410 and a memory unit 420. Memory 420 may comprise, for example, application server 160(A) and/or invoice server 145. While executing on processing unit 410, application server 160(A) and/or invoice server 145 may perform processes for providing embodiments of the invention as described above.

Computing device 400 may be implemented using a personal computer, a network computer, a server, a mainframe, or other similar microcomputer-based workstation. The processor may comprise any computer operating environment, such as hand-held devices, multiprocessor systems, microprocessor-based or programmable sender electronic devices, minicomputers, mainframe computers, and the like. The processor may also be practiced in distributed computing environments where tasks are performed by remote processing devices. Furthermore, the processor may comprise a mobile terminal, such as a smart phone, a cellular telephone, a cellular telephone utilizing wireless application protocol (WAP), personal digital assistant (PDA), intelligent pager, portable computer, a hand held computer, a conventional telephone, a wireless fidelity (Wi-Fi) access point, or a facsimile machine. The aforementioned systems and devices are examples and the processor may comprise other systems or devices.

An embodiment consistent with the invention may comprise a system for providing billing for agricultural services. The system may comprise a memory storage and a processing unit coupled to the memory storage. The processing unit may be operative to receive a plurality of data from a machine, determine whether the machine is associated with a subscribing user, and, in response to determining that the machine is identified with the subscribing user, identify an application service associated with the machine, provide the plurality of data to the application service, and create a charge record associated with the subscribing user. The processing unit may be further operative to determine whether the subscribing user is associated with a pre-paid account and, if not, generate an invoice to the subscribing user comprising the charge record and provide the invoice to the subscribing user. The invoice may comprise a plurality of charge records and/or may be generated on a periodic basis. The plurality of charge records may be associated with a plurality of machines and/or a plurality of application services. Each charge record may comprise a user identifier associated with the subscribing user, a machine identifier associated with the machine, and/or an application service identifier associated with the application service. If the subscribing user is associated with a pre-paid account, the processing unit may be further operative to debit the pre-paid account an amount associated with the charge record and provide a receipt to the subscribing user. The plurality of data may be received, for example, from a portable data storage device, a wireless network transmission, and a wired transmission.

Another embodiment consistent with the invention may comprise a system for providing billing for agricultural services. The system may comprise a memory storage and a processing unit coupled to the memory storage. The processing unit may be operative to receive a plurality of data records from a machine, determine whether at least one of the plurality of data records is associated with an application service, in response to determining that the at least one of the plurality of data records is associated with the application service, determine whether an account associated with the machine is authorized to access the application service, and in response to determining that the account associated with the machine is authorized to access the application service, charge the account associated with the machine for access to the application service and provide the at least one of the plurality of data records to the application service. Being operative to charge the account associated with the machine may comprise the processing unit being operative to create a charge data record associated with the at least one of the plurality of data records and store the charge data record in a billing database. The processing unit may be further operative to generate an invoice comprising a plurality of charge data records stored in the billing database associated with the account. The charge data record may comprise a cost associated with access to the application service wherein the cost associated with access to the application service is received from a provider of the application service. The processing unit may be further operative to determine whether the account comprises a pre-paid account and, in response to determining that the account comprises the pre-paid account, debit the pre-paid account an amount associated with access to the application service.

Yet another embodiment consistent with the invention may comprise a system for providing billing for agricultural services. The system may comprise a memory storage and a processing unit coupled to the memory storage. The processing unit may be operative to receive a data transfer from a machine, identify at least one application service associated with processing the data transfer, generate a charge to an account associated with the machine for access to the at least one application service, send at least a portion of the data transfer to the application service for processing, and provide a charge report to an owner of the machine. The charge to the account may comprise, for example, a debit to a pre-paid account and/or a charge record stored in a billing database and the charge report comprises an invoice comprising a plurality of charge records associated with the account retrieved from the billing database. The data transfer may comprise additional information such as a work area identifier, an operator identifier, a time of data collection, a harvest amount, a yield calculation, and a parameter measurement. The processing unit may be further operative to include the additional information on the charge report.

While certain embodiments of the invention have been described, other embodiments may exist. While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

We claim:

1. A method for providing billing for application services, the method comprising:
receiving a plurality of data from a machine;
determining whether the machine is associated with a subscribing user;
in response to determining that the machine is identified with the subscribing user, identifying an application service associated with the machine;
providing the plurality of data to the application service; and
creating a charge record associated with the subscribing user.

2. The method of claim 1, further comprising:
determining whether the subscribing user is associated with a pre-paid account; and
in response to determining that the subscribing user is not associated with a pre-paid account:
generating an invoice to the subscribing user comprising the charge record, and
providing the invoice to the subscribing user.

3. The method of claim 2, further comprising generating the invoice to the subscribing user comprising a plurality of charge records.

4. The method of claim 3, wherein the invoice is generated on a periodic basis.

5. The method of claim 2, further comprising, in response to determining that the subscribing user is associated with a pre-paid account:
debiting the pre-paid account an amount associated with the charge record; and
providing a receipt to the subscribing user.

6. The method of claim 2, wherein the plurality of charge records are associated with a plurality of machines.

7. The method of claim 2, wherein the plurality of charge records are associated with a plurality of application services.

8. The method of claim 1, wherein the charge record comprises a user identifier associated with the subscribing user, a machine identifier associated with the machine, and an application service identifier associated with the application service.

9. The method of claim 1, wherein the charge record is associated with a plurality of data transmissions from the machine.

10. The method of claim 1, wherein the plurality of data is received from at least one of the following: a portable data storage device, a wireless network transmission, and a wired transmission.

11. A system for providing billing for application services, the system comprising:
a memory storage; and
a processing unit coupled to the memory storage, wherein the processing unit is operative to:
receive a plurality of data records from a machine,
determine whether at least one of the plurality of data records is associated with an application service,
in response to determining that the at least one of the plurality of data records is associated with the application service, determine whether an account associated with the machine is authorized to access the application service, and
in response to determining that the account associated with the machine is authorized to access the application service,
charge the account associated with the machine for access to the application service, and
provide the at least one of the plurality of data records to the application service.

12. The system of claim 11, wherein being operative to charge the account associated with the machine comprises being operative to:
create a charge data record associated with the at least one of the plurality of data records; and
store the charge data record in a billing database.

13. The system of claim 12, wherein the processing unit is further operative to generate an invoice comprising a plurality of charge data records stored in the billing database associated with the account.

14. The system of claim 12, wherein the charge data record comprises a cost associated with access to the application service and wherein the cost associated with access to the application service is received from a provider of the application service.

15. The system of claim 11, wherein being operative to charge the account associated with the machine comprises being operative to:
determine whether the account comprises a pre-paid account; and
in response to determining that the account comprises the pre-paid account, debit the pre-paid account an amount associated with access to the application service.

16. A computer-readable medium which stores a set of instructions which when executed performs a method for providing billing for application services, the method executed by the set of instructions comprising:
receiving a data transfer from a machine;
identifying at least one application service associated with processing the data transfer;
generating a charge to an account associated with the machine for access to the at least one application service;
sending at least a portion of the data transfer to the application service for processing; and
providing a charge report to an owner of the machine.

17. The computer-readable medium of claim 16, wherein the charge to the account comprises a debit to a pre-paid account.

18. The computer-readable medium of claim 16, wherein the charge to the account comprises a charge record stored in a billing database and the charge report comprises an invoice comprising a plurality of charge records associated with the account retrieved from the billing database.

19. The computer-readable medium of claim 16, wherein the data transfer further comprises additional information comprising at least one of the following: a work area identifier, an operator identifier, a time of data collection, a harvest amount, a yield calculation, and a parameter measurement.

20. The computer-readable medium of claim 16, wherein the charge report comprises the additional information.
